(19) United States
(12) Patent Application Publication
(10) Pub. No.: US 2022/0375659 A1
(43) Pub. Date: Nov. 24, 2022

(54) PTC HEATING ELEMENT

(71) Applicant: Mahle International GmbH, Stuttgart (DE)

(72) Inventors: Alexander Daniel, Stuttgart (DE); Marcel Huelss, Stuttgart (DE); Peter Schluenzen, Stuttgart (DE); Falk Viehrig, Stuttgart (DE); Robin Wanke, Stuttgart (DE); Denis Wiedmann, Fellbach (DE)

(21) Appl. No.: 17/739,118

(22) Filed: May 7, 2022

(30) Foreign Application Priority Data
May 12, 2021 (DE) 10 2021 204 888.9

(51) Int. Cl. H01C 7/02; H05B 3/12

(52) U.S. Cl. CPC H01C 7/021; H01C 7/028; H05B 3/12; H05B 2203/017; H05B 2203/02

(57) ABSTRACT

The invention relates to a PTC heating element (1). The PTC heating element (1) comprises a block-shaped PTC thermistor (2) having two contact surfaces (4a, 4b) and two electrically conductive contact plates (3a, 3b). The PTC thermistor (2) is arranged between the contact plates (3a, 3b) and facing the contact plates (3a, 3b) with the contact surfaces (4a, 4b). An adhesion-promoting electrically conductive bonding layer (6a, 6b) each is arranged between the contact surface (4a, 4b) and the contact plate (3a, 3b). The PTC thermistor (2) is firmly connected to the respective contact plates (3a, 3b) by means of the respective bonding layers (6a, 6b) and electrically conductively contacted.

The adhesion-promoting electrically conductive bonding layer (6a, 6b) according to the invention comprises silicone or consists thereof.

The invention relates to a PTC heating element having a block-shaped PTC thermistor and having two electrically conductive contact plates according to the preamble of claim 1.

A PTC heating element usually includes a block-shaped PTC thermistor which is arranged between two contact plates. When a voltage is applied to the contact plates the PTC thermistor can generate heat. In order to ensure the function of the PTC heating element a continuous electrically conductive contact between the contact plates and the PTC thermistor is necessary. It is known for example to jam the PTC thermistor between the contact plates without any intermediate layers. In addition, the PTC thermistor can be fastened to the contact plates by means of a contact lug and the electrical contact ensured. PTC usually stands for positive temperature coefficient and is known to relate to semi-conductor materials whose electrical resistance depends on the temperature.

In addition it is known for example to bond the PTC thermistor to the contact plates by means of a dielectric bonding material. So as not to impair the electrically conductive contact between the contact plates and the PTC thermistor, the layer thickness of the bonding material is very thin. There, disadvantageously, the bonding material cannot compensate for the tolerances of the PTC thermistor so that contacting problems between the PTC thermistor and the contact plates can occur in places. From EP 1 523 225 B1 it is known for example to use an electrically conductive bonding material. However it is disadvantageous here that the bonding material can ooze out as a result of the contact plates being pressed together and a short circuit cannot be safely excluded.

The object of the invention therefore is to state for a PTC heating element of the generic type an improved or at least alternative embodiment in which the described disadvantages are overcome.

According to the invention, this object is solved through the subject of the independent claim 1. Advantageous embodiments are subject of the dependent claims.

A PTC heating element comprises a block-shaped PTC thermistor having two contact surfaces located opposite one another and two electrically conductive contact plates. Here, the PTC thermistor is arranged between the two contact plates and facing the respective contact plates with the respective contact surfaces. In addition, between the respective contact surface and the respective contact plate an adhesion-promoting electrically conductive bonding layer each is arranged. There, the PTC thermistor is firmly connected to the respective contact plates by means of the respective bonding layers and contacted in an electrically conductive manner. The adhesion-promoting electrically conductive bonding layer according to the invention comprises silicone or consists thereof.

The adhesion-promoting bonding layer which comprises silicone or consists of silicone is electrically conductive. Because of this, the bonding layer can have a greater layer thickness than conventional dielectric bonding materials since a direct electrically conductive contact between the bonding layer and the PTC thermistor is not necessary. Accordingly, the layer thickness of the bonding layer can be matched to the tolerances of the PTC thermistor. In addition, the adhesion-promoting bonding layer, which comprises silicone or consists of silicone, is temperature-resistant and flexible. Because of this, fractures of the adhesion-promoting bonding layer can be advantageously avoided.

The electrical conductivity of the adhesion-promoting electrically conductive bonding layer can be adapted here in such a manner that an adequate current conduction between the contact plates and the PTC thermistor is made possible. The electrical conductivity of the adhesion-promoting electrically conductive bonding layer can be additionally adapted in such a manner that a short circuit and overheating of the PTC thermistor are excluded. Because of this, the operational safety of the PTC heating element with respect to the short circuit and adherence to air gaps and creep distances can be maintained.

Advantageously it can be provided that the specific resistance of the respective bonding layer is between 500 Ωcm and 50,000 Ωcm.

Advantageously it can be provided that the respective bonding layer completely covers the respective contact surface of the PTC thermistor. Advantageously it can be provided that the respective bonding layer completely covers exclusively the respective contact surface of the PTC thermistor. In this case, no lateral surface connecting the two contact surfaces of the PTC thermistor is wetted by the bonding layer. Accordingly, the air gaps and creep distances between the two contact plates are completely adhered to. Because of this, a short circuit and overheating of the PTC thermistor are excluded.

For this case it can be advantageously provided that the specific resistance of the bonding layer is greater than a minimum value of the specific resistance. Here, the minimum value of the specific resistance corresponds to a product of a minimum safety factor of 5 and an operating voltage of the PTC heating element. The minimum safety factor here is stated in Ωcm/volt operating voltage. Advantageously, the operating voltage of the PTC heating element can be between 350 V and 1250 V.

In the following, the minimum values of the specific resistance of the bonding layer are exemplarily stated. When the operating voltage of the PTC heating element amounts to 350 V, the minimum value of the specific resistance of the bonding layer is 350 V*5 Ωcm/V=1,750 Ωcm. When the operating voltage of the PTC heating element amounts to 450 V, the minimum value of the specific resistance of the bonding layer is 450 V*5 Ωcm/V=2,250 Ωcm. When the operating voltage of the PTC heating element amounts to 850 V, the minimum value of the specific resistance of the bonding layer is 850 V*5 Ωcm/V=4,250 Ωcm. When the operating voltage of the PTC heating element amounts to 1,250 V, the minimum value of the specific resistance of the bonding layer is 1,250 V*5 Ωcm/V=6,250 Ωcm.

Advantageously it can be provided that the respective bonding layer partially wets at least one lateral surface connecting the two contact surfaces of the PTC thermistor and is electrically insulated from the respective other bonding layer via the lateral surface. In this case, the air gap and creep distances between the two contact plates are shortened. However, as soon as the minimum value of the specific resistance is not undershot, a short circuit and overheating of the PTC thermistor can be safely excluded.

For this case it can be advantageously provided that the specific resistance of the bonding layer is equal to a preferred value of the specific resistance. Here, the preferred value of the specific resistance corresponds to a product of a preferred safety factor of 20 and an operating voltage of the PTC heating element. The preferred safety factor is stated in Ωcm/volt operating voltage. Advantageously, the operating voltage of the PTC heating element can be between 350 V and 1,250 V.

In the following, the preferred values of the specific resistance of the bonding layer are exemplarily stated. When the operating voltage of the PTC heating element amounts to 350 V, the preferred value of the specific resistance of the bonding layer is 350 V*20 Ωcm/V=7,000 Ωcm. When the operating voltage of the PTC heating element amounts to 450 V, the preferred value of the specific resistance of the bonding layer is 450 V*20 Ωcm/V=9,000 Ωcm. When the operating voltage of the PTC heating element amounts to 850 V, the preferred value of the specific resistance of the bonding layer is 850 V*20 Ωcm/V=17,000 Ωcm. When the operating voltage of the PTC heating element amounts to 1,250 V, the preferred value of the specific resistance of the bonding layer is 1,250 V*20 Ωcm/V=25,000 Ωcm.

Advantageously it can be provided that at least one of the respective bonding layers partially wets at least one lateral surface connecting the two contact surfaces of the PTC thermistor and is electrically conductively connected to the respective other bonding layer via the lateral surface. In this case, the air gap and creep distances between the two contact plates are bridged by the bonding layer. However, as soon as the minimum value of the specific resistance is not undershot, a short circuit and overheating of the PTC thermistor can be safely excluded.

For this case that the lateral surfaces are electrically conductively connected, it can be advantageously provided that the specific resistance of the bonding layer is smaller than a maximum value of the specific resistance. Here, the maximum value of the specific resistance corresponds to a product of a maximum safety factor of 40 and an operating voltage of the PTC heating element. The maximum safety factor is stated in Ωcm/volt operating voltage. Advantageously, the operating voltage of the PTC heating element can be between 350 V and 1,250 V.

In the following, the maximum values of the specific resistance of the bonding layer are exemplarily stated. When the operating voltage of the PTC heating element amounts to 350 V, the maximum value of the specific resistance of the bonding layer is 350 V*40 Ωcm/V=14,000 Ωcm. When the operating voltage of the PTC heating element amounts to 450 V, the maximum value of the specific resistance of the bonding layer is 450 V*40 Ωcm/V=18,000 Ωcm. When the operating voltage of the PTC heating element amounts to 850 V, the maximum value of the specific resistance of the bonding layer is 850 V*40 Ωcm/V=34,000 Ωcm. When the operating voltage of the PTC heating element amounts to 1,250 V, the maximum value of the specific resistance of the bonding layer is 1,250 V*40 Ωcm/V=50,000 Ωcm.

For this case that the lateral surfaces are electrically conductively connected, it can be advantageously provided additionally that the specific resistance of the bonding layer is preferably equal to a quotient between a product of a multiplication factor of 40 with an operating voltage of the PTC heating element and a thickness of the PTC thermistor. Here, the thickness of the PTC thermistor is defined by the distance of the two contact surfaces to one another. The multiplication factor is stated in Ωcm*mm thickness/volt operating voltage. Advantageously, the thickness of the PTC thermistor can be between 1.5 mm and 3.5 mm.

In the following, the preferred values of the specific resistance of the bonding layer as a function of the thickness are exemplarily stated. When the operating voltage of the PTC heating element amounts to 350 V and the PTC thermistor thickness 2 mm, the maximum value of the specific resistance of the bonding layer is 350 V*40 Ωcm*mm/V/2 mm=7,000 Ωcm. When the operating voltage of the PTC heating element amounts to 450 V and the PTC thermistor to 2 mm, the maximum value of the specific resistance of the bonding layer is 450 V*40 Ωcm*mm/V/2 mm=9,000 Ωcm. When the operating voltage of the PTC heating element amounts to 850 V [symbol] the PTC thermistor thickness to 2.5 mm, the maximum value of the specific resistance of the bonding layer is 850 V*40 Ωcm*mm/V/2.5 mm=13,600 Ωcm. When the operating voltage of the PTC heating element amounts to 1,250 V [symbol] the PTC thermistor thickness to 3 mm, the maximum value of the specific resistance of the bonding layer is 1,250 V*40 Ωcm*mm/V/3.5 mm=14,285 Ωcm.

Advantageously it can be provided that the respective bonding layer is applied to the respective contact surface of the PTC thermistor and/or to the respective contact plate by means of a screen print.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

It shows, in each case schematically

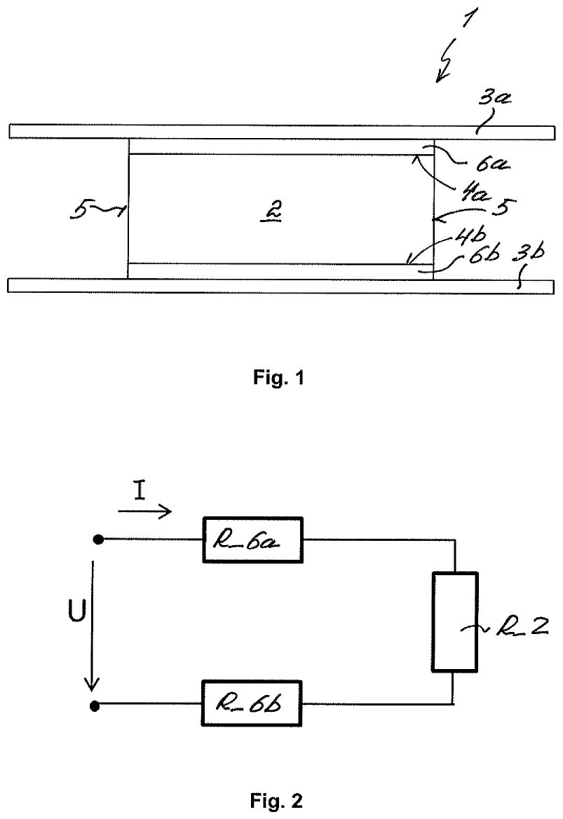

FIG. 1 a sectional view of a PTC heating element according to the invention;

FIG. 2 an equivalent circuit diagram of the PTC heating element according to the invention shown in FIG. 1;

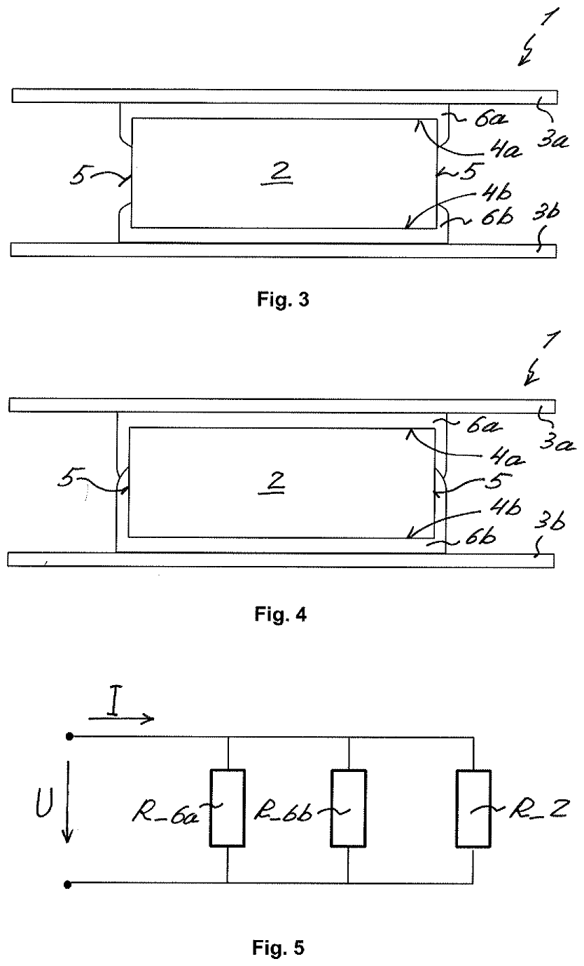

FIG. 3 a sectional view of the PTC heating element according to the invention configured differently;

FIG. 4 a sectional view of the PTC heating element according to the invention configured differently;

FIG. 5 an equivalent circuit diagram of the PTC heating element according to the invention shown in FIG. 4.

FIG. 1 shows a sectional view of a PTC heating element 1 according to the invention. Here, the PTC heating element 1 comprises a block-shaped PTC thermistor 2 and two electrically conductive contact plates 3a and 3b, wherein the PTC thermistor 2 is arranged between the contact plates 3a and 3b. Here, the PTC thermistor comprises two opposite contact surfaces 4a and 4b and multiple—altogether four—lateral surfaces 5. Here, the lateral surfaces 5 connect the two opposite contact surfaces 4a and 4b of the PTC thermistor with one another.

The PTC thermistor 2 is arranged with the respective contact surface 4a and 4b respectively facing the respective contact plate 3a and 3b respectively. Between the respective contact surface 4a and 4b and the respective contact plate 3a and 3b respectively an adhesion-promoting electrically conductive bonding layer 6a and 6b is arranged which comprises or consists of silicone. By means of the bonding layer 6a and 6b respectively, the PTC thermistor 2 is electrically conductively contacted on the respective contact surface 4a and 4b respectively with the respective contact plate 3a and 3b respectively.

In FIG. 1, the respective bonding layer 6a and 6b respectively covers exclusively the respective contact surface 4a and 4b respectively of the PTC thermistor 2. Because of this, the lateral surfaces 5 are not wetted by the respective bonding layer 6a and 6b respectively. Accordingly, the air gap and creep distances between the two contact plates 3a and 3b are completely adhered to or are not shortened. A short circuit and overheating of the PTC thermistor are excluded here. This is a so-called ideal case.

FIG. 2 shows an equivalent circuit diagram of the PTC heating element 1 shown in FIG. 1. There, the electrical resistance R_6a and R_6b respectively represents the electrical resistance of the bonding layer 6a and 6b respectively. The electrical resistance R_2 further represents the electrical resistance of the PTC thermistor 2. The bonding layer resistance R_SI is composed of the resistance R_6a and R_6b of the two bonding layers 6a and 6b. The total resistance R_G is then composed of the resistances R_6a, R_6b and R_2 or R_SI and R_2. The electrical voltage U is applied to the two contact plates 3a and 3b and the electric current I then flows from the contact plate 3a via the bonding layer 6a, the PTC thermistor 2, the bonding layer 6b to the contact plate 3b.

According to the design requirements on electrical interfaces, maximally 5% of the applied voltage U should drop on the bonding layer 6a and 6b respectively and altogether maximally 10% on the bonding layers 6a and 6b. Thus, the following should apply:

It follows the relationship:

R_{SI}≤0.1*R_{G}.

The bonding layer resistance R_SI of the bonding layers 6a and 6b is obtained according to the formula

$${R}_{SI} = {ρ}_{SI} * \frac{2 d}{A} ,$$

wherein ρ_SI is the specific resistance of the bonding layer 6a and 6b respectively; A is a geometrical surface area of the contact surface 4a and 4b respectively; and d is a thickness of the bonding layer 6a and 6b respectively.

With an exemplary operating voltage U of 450 V a resistance R_2 of the PTC thermistor of approximately 400Ω is obtained. The bonding layer 6a and 6b respectively can have an exemplary specific resistance ρ_SI of 20,000 Ωcm. With an exemplary geometrical surface area A of the respective contact surface 4a and 4b respectively of (39.8*16) mm² and an exemplary thickness d of the bonding layer 6a and 6b respectively of 20 μm, a value of 12.56Ω is obtained for the electrical resistance R_SI of the bonding layers 6a and 6b. Accordingly, the electrical resistance R_SI of 12.56Ω is smaller than 10% of the electrical resistance R_2 of the PTC thermistor 2 of 400Ω. Thus, the requirements on the bonding layers 6a and 6b are satisfied.

FIG. 3 shows a sectional view of the differently designed PTC heating element 1 according to the invention. Here, the respective bonding layers 6a and 6b partially wet the lateral surfaces 5 but are electrically insulated from one another via the lateral surfaces 5. In this case, the air gap and creep distances between the two contact plates are shortened. This is a so-called normal case in which through the pressing together of the contact plates 3a and 3b the bonding layers 6a and 6b flow between the contact plates 3a and 3b and wet the lateral surfaces 5.

FIG. 4 shows a sectional view of the differently designed PTC heating element 1 according to the invention. Here, the bonding layers 6a and 6b wet the lateral surfaces 5 and are electrically conductively connected to one another via the lateral surfaces 5. Because of this, an electrically conductive connection is established between the two bonding layers 6a and 6b. This is a so-called extreme case in which the air gap and creep distances between the two contact plates 3a and 3b are bridged by the bonding layers 6a and 6b.

FIG. 5 shows an equivalent circuit diagram of the PTC heating element 1 according to the invention shown in FIG. 4. Here, the electrical resistance R_6a and R_6b respectively represent the electrical resistance of the bonding layer 6a and 6b respectively. Further, the electrical resistance R_2 represents the electrical resistance of the PTC thermistor 2. Here, the electrical voltage U is applied to the two contact plates 3a and 3b and the electric current I then flows from the contact plate 3a to the contact plate 3b simultaneously via the bonding layers 6a and 6b and the PTC thermistor 2.

In order to avoid a short circuit and overheating of the PTC thermistor also in the shown extreme case the specific resistance of the bonding layer 6a and 6b should be sufficiently high. The power loss P_V created by the drop of the voltage U on the bonding layers may, according to the requirements, correspond to maximally 10% of a total power P_G of the PTC heating element 1:

P_{V}≤0.1*P_{G}

Thus the following applies:

$$\frac{{U}^{2}}{{P}_{V}} \leq {R}_{6 a} + {R}_{6 b}$$

Assuming that the electrical resistance R_6a and the electrical resistance R_6b are identical, an exemplary operating voltage U of 450 V and an exemplary electrical resistance R_2 of the PTC thermistor 2 of 400Ω, the following is obtained for the electrical resistances R_6a and R_6b each:

$${R}_{6 a} / {R}_{6 b} \leq \frac{{( 450 V )}^{2}}{25 W}$$

The electrical resistance R_6a and R_6b respectively of the respective bonding layer 6a and 6b respectively may thus amount to minimally 8,100 Ωeach. Because of the high specific resistance ρ_SI of the respective bonding layer 6a and 6b respectively of 20,000Ω—as explained with respect to FIG. 2—and a low cross-section and a short length of the electrically conductive connection between the two bonding layers 6a and 6b this is thus satisfied.

1. A PTC heating element, comprising:
a block-shaped PTC thermistor having two opposite contact surfaces;
two electrically conductive contact plates;
the PTC thermistor arranged between the two contact plates with a respective contact surface of the two contact surfaces facing a respective contact plate of the two contact plates;
a respective bonding layer of a plurality of adhesion-promoting electrically conductive bonding layers arranged between the respective contact surface and the respective contact plate;
wherein the PTC thermistor is firmly connected and electrically conductively contacted with the two contact plates via the plurality of bonding layers; and
wherein the plurality of bonding layers include silicone.

2. The PTC heating element according to claim 1, wherein the plurality of bonding layers have a specific resistance of 500 Ωcm to 50,000 Ωcm.

3. The PTC heating element according to claim 1, wherein:
a specific resistance of the plurality of bonding layers is greater than a minimum value of the specific resistance; and
the minimum value of the specific resistance corresponds to a product of a minimum safety factor of 5 and an operating voltage of the PTC heating element.

4. The PTC heating element according to claim 1, wherein:
a specific resistance of the plurality of bonding layers is equal to a preferred value of the specific resistance; and
the preferred value of the specific resistance corresponds to a product of a preferred safety factor of 20 and an operating voltage of the PTC heating element.

5. The PTC heating element according to claim 1, wherein:
a specific resistance of the plurality of bonding layers is smaller than a maximum value of the specific resistance; and
the maximum value of the specific resistance corresponds to a product of a maximum safety factor of 40 and an operating voltage of the PTC heating element.

6. The PTC heating element according to claim 1, wherein a specific resistance of the plurality of bonding layers is equal to a quotient between a product of a multiplication factor of 40 with an operating voltage of the PTC heating element and a thickness of the PTC thermistor.

7. The PTC heating element according to claim 1, wherein the respective bonding layer completely covers the respective contact surface.

8. The PTC heating element according to claim 1, wherein:
a first bonding layer of the plurality of bonding layers partially wets at least one lateral surface connecting the two contact surfaces of the PTC thermistor; and
the first bonding layer is electrically insulated from a second bonding layer of the plurality of bonding layers via the lateral surface.

9. The PTC heating element according to claim 1, wherein at least one of the plurality of bonding layers partially wets at least one lateral surface connecting the two contact surfaces of the PTC thermistor and is electrically conductively connected to another bonding layer of the plurality of bonding layers via the at least one lateral surface.

10. The PTC heating element according to claim 1, wherein an operating voltage of the PTC heating element is 350 V to 1,250 V.

11. The PTC heating element according to claim 1, wherein the respective bonding layer completely and exclusively covers the respective contact surface.

12. The PTC heating element according to claim 1, wherein the plurality of bonding layers are configured as screen-print layers.

13. The PTC heating element according to claim 1, wherein a bonding layer electrical resistance R_{SI} of the plurality of bonding layers is 10% or less of a total electrical resistance R_{G}.

14. The PTC heating element according to claim 13, wherein the total electrical resistance R_{G} is composed of an electrical resistance R₂ of the PTC thermistor and the bonding layer electrical resistance R_{SI}.

15. The PTC heating element according to claim 14, wherein:
ρ_{SI} is a specific resistance of each of the plurality of bonding layers;
d is a thickness of each of the plurality of bonding layers;
A is a surface area of each of the two contact surfaces; and
the bonding layer electrical resistance R_{SI} is equal to ρ_{SI}*2*d/A.

16. The PTC heating element according to claim 1, wherein a power loss P_{V} provided by a drop of voltage U on the plurality of bonding layers is 10% or less of a total power P_{G} of the PTC heating element.

17. The PTC heating element according to claim 16, wherein:
the plurality of bonding layers includes a first bonding layer and a second bonding layer;
the first bonding layer has an electrical resistance R₆ₐ;
the second bonding layer has an electrical resistance R_{6b}; and
U²/P_{V}≤R₆ₐ+R_{6b}.

18. A PTC heating element, comprising:
two electrically conductive contact plates;
a block-shaped PTC thermistor having two opposite contact surfaces, the PTC thermistor arranged between the two contact plates such that (i) a first contact surface of the two contact surfaces faces a first contact plate of the two contact plates and (ii) a second contact surface of the two contact surfaces faces a second contact plate of the two contact plates;
a plurality of adhesion-promoting electrically conductive bonding layers via which the PTC thermistor is firmly connected and electrically conductively contacted with the two contact plates, the plurality of bonding layers including (i) a first bonding layer arranged between and connecting the first contact surface and the first contact plate and (ii) a second bonding layer arranged between and connecting the second contact surface and the second contact plate; and
wherein the plurality of bonding layers include silicone.

19. The PTC heating element according to claim 18, wherein:
the PTC thermistor has at least one lateral surface extending between and connecting the two contact surfaces;
the first bonding layer at least partially wets the at least one lateral surface; and
the first bonding layer is electrically insulated from the second bonding layer via the at least one lateral surface.

20. The PTC heating element according to claim 18, wherein:
the PTC thermistor has at least one lateral surface extending between and connecting the two contact surfaces;
the first bonding layer at least partially wets the at least one lateral surface; and
the first bonding layer is electrically conductively connected to the second bonding layer via the at least one lateral surface.
